(19) United States
(12) Patent Application Publication
(10) Pub. No.: US 2019/0045774 A1
(43) Pub. Date: Feb. 14, 2019

(54) Deer Decoy Assembly

(71) Applicant: Donald Roberts, Hemingway, SC (US)

(72) Inventor: Donald Roberts, Hemingway, SC (US)

(21) Appl. No.: 15/676,244

(22) Filed: Aug. 14, 2017

(51) Int. Cl. A01M 31/00; A01M 31/06; F41J 1/10; H04R 1/02; G06F 3/16

(52) U.S. Cl. CPC A01M 31/004; A01M 31/06; H04R 2420/07; H04R 1/028; G06F 3/165; F41J 1/10

(57) ABSTRACT

A deer decoy assembly includes a decoy that is selectively positioned in a hunting area. The decoy is structured to resemble a deer to attract deer. A pair of antlers is provided and each of the antlers is removably coupled to the head on the decoy. In this way the decoy is structured to selectively resemble a buck and a doe. A tail is removably coupled to the rump and the tail is comprised of a fluid absorbent material. The tail selectively absorbs a liquid scent to emit the scent for attracting the deer. A call unit is coupled to the decoy and the call unit selectively emits an audible sound to attract the deer to the decoy. A remote unit is in wireless electrical communication with the call unit to selectively actuate the call unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to decoy devices and more particularly pertains to a new decoy device for attracting deer for hunting.

### BRIEF SUMMARY OF THE INVENTION

An embodiment of the disclosure meets the needs presented above by generally comprising a decoy that is selectively positioned in a hunting area. The decoy is structured to resemble a deer to attract deer. A pair of antlers is provided and each of the antlers is removably coupled to the head on the decoy. In this way the decoy is structured to selectively resemble a buck and a doe. A tail is removably coupled to the rump and the tail is comprised of a fluid absorbent material. The tail selectively absorbs a liquid scent to emit the scent for attracting the deer. A call unit is coupled to the decoy and the call unit selectively emits an audible sound to attract the deer to the decoy. A remote unit is in wireless electrical communication with the call unit to selectively actuate the call unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a deer decoy assembly according to an embodiment of the disclosure.

FIG. 2 is a bottom view of an embodiment of the disclosure.

FIG. 3 is a right side view of an embodiment of the disclosure.

FIG. 4 is a front view of an embodiment of the disclosure.

FIG. 5 is a perspective view of remote unit of an embodiment of the disclosure.

FIG. 6 is a cross sectional view of an embodiment of the disclosure.

FIG. 7 is a schematic view of an embodiment of the disclosure.

### DETAILED DESCRIPTION OF THE INVENTION

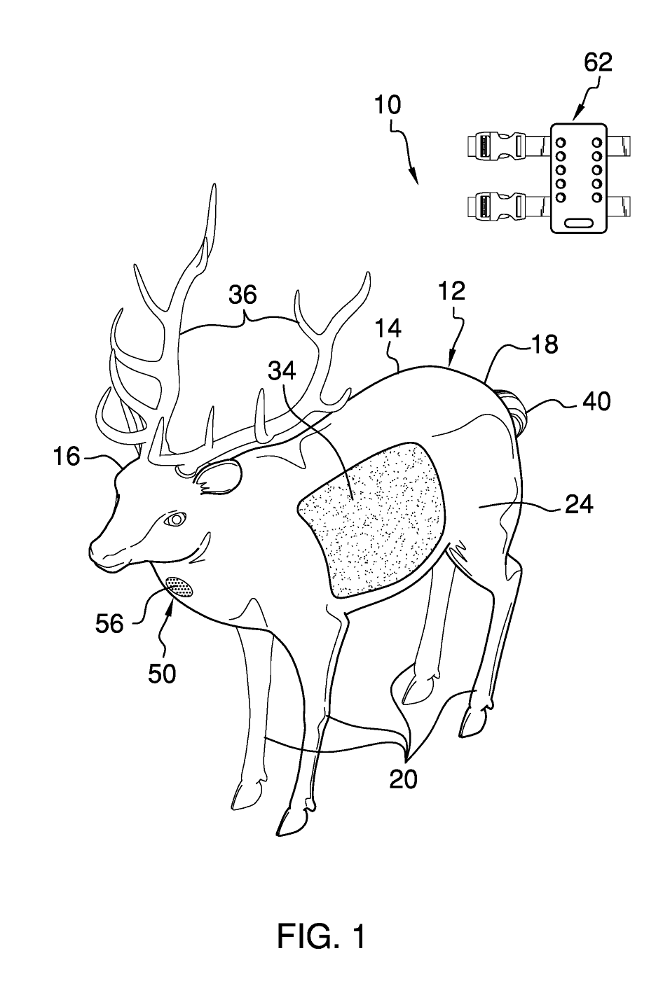

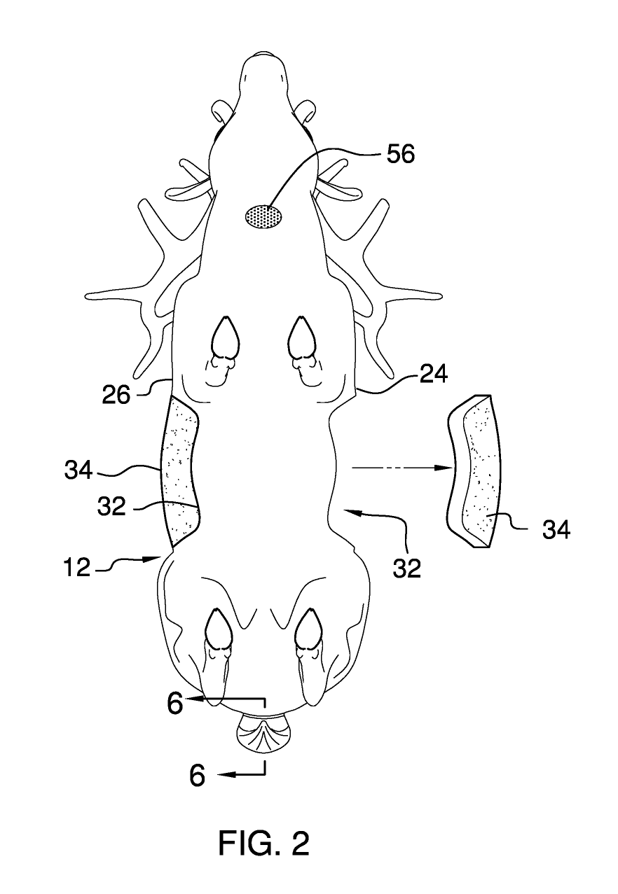

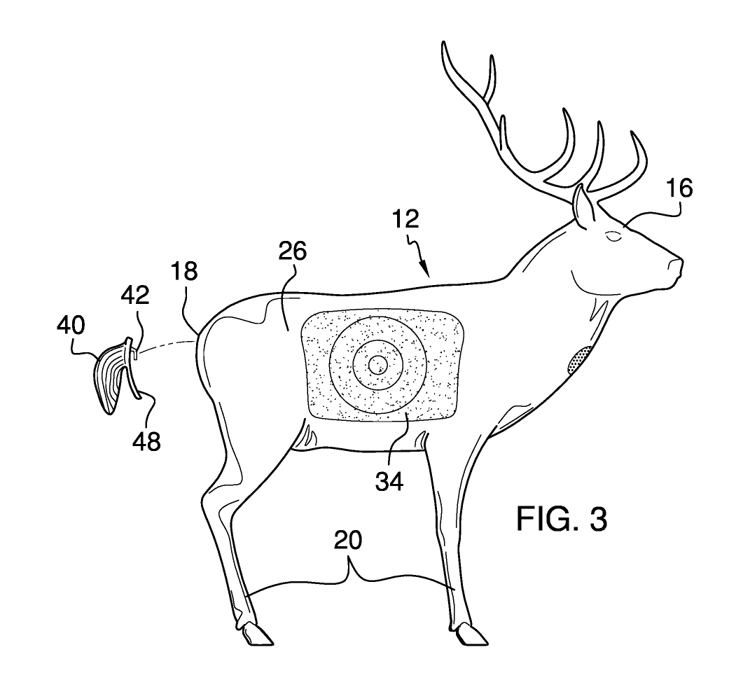

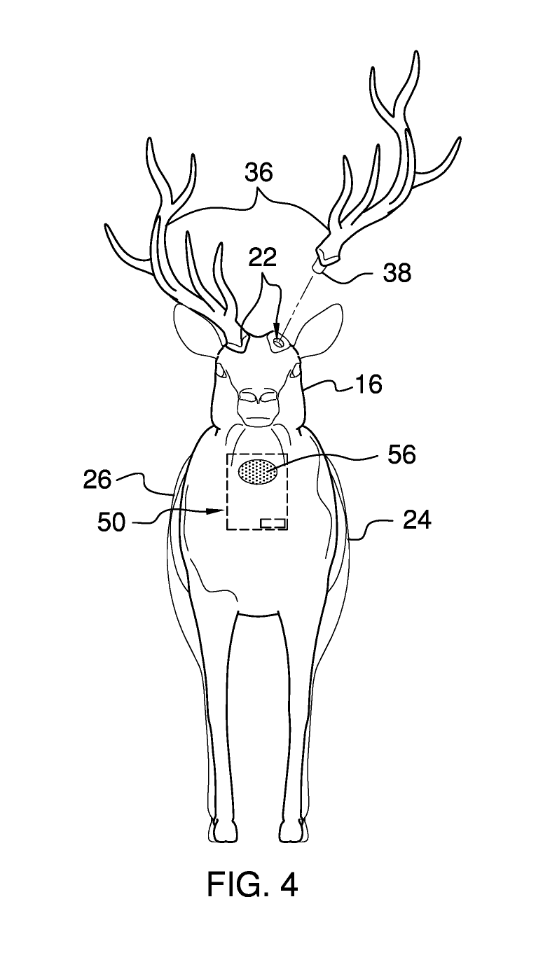

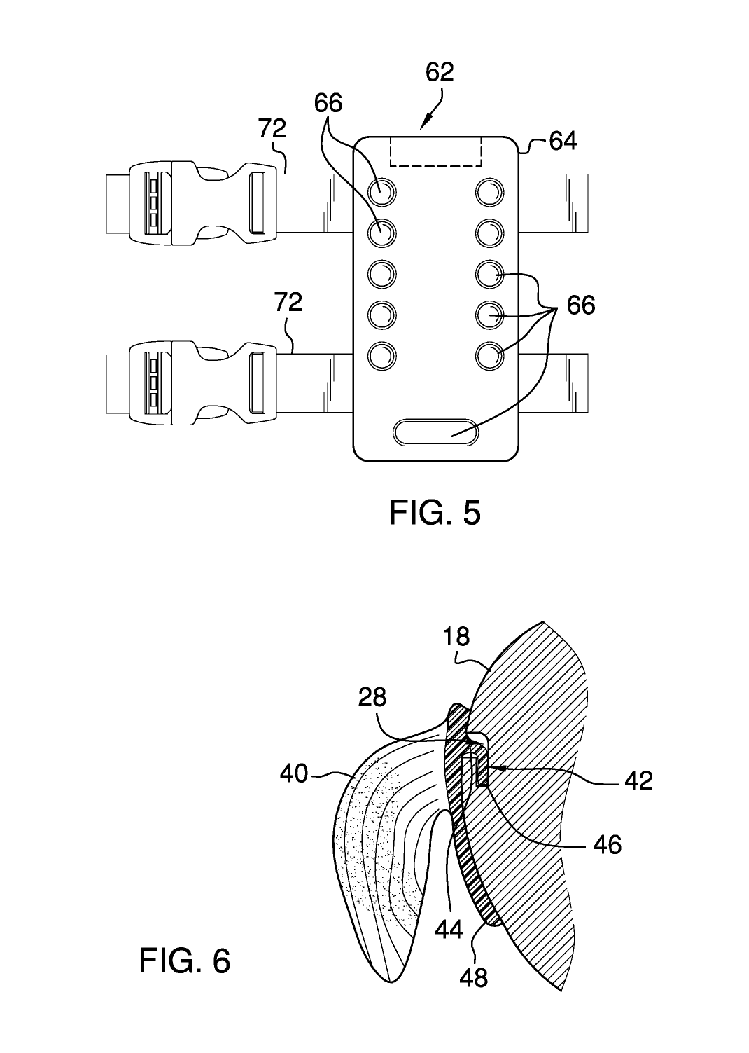

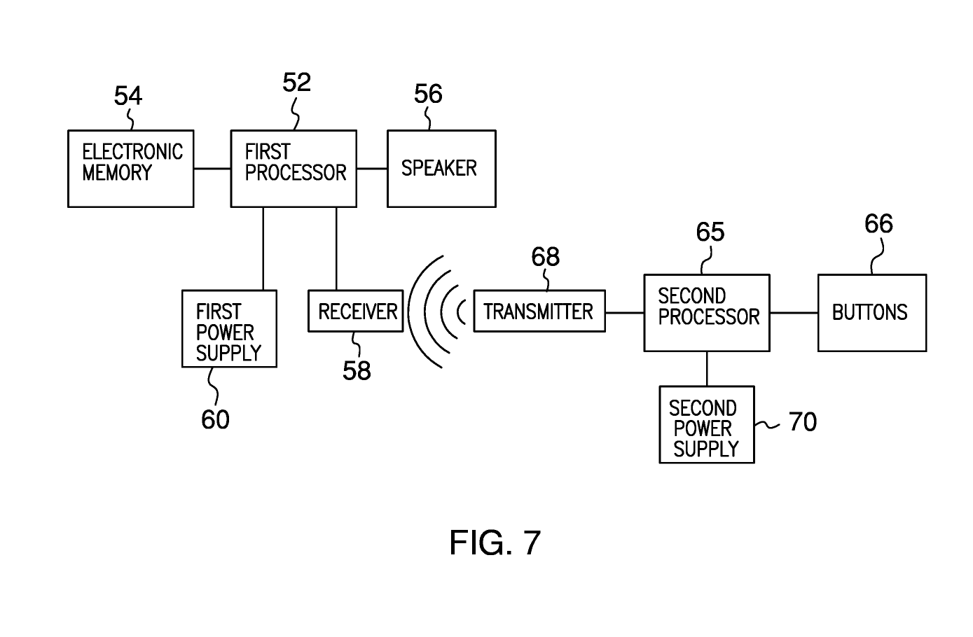

With reference now to the drawings, and in particular to FIGS. 1 through 7 thereof, a new decoy device embodying the principles and concepts of an embodiment of the disclosure and generally designated by the reference numeral 10 will be described.

As best illustrated in FIGS. 1 through 7, the deer decoy assembly 10 generally comprises a decoy 12 that may be positioned in a hunting area. The decoy 12 is structured to resemble a deer to attract deer. The deer may be any species of deer, including but not being limited to, white tail deer, mule deer and black tail deer. Moreover, the decoy 12 may be structure to resemble moose, elk, antelope and any other antlered game.

The decoy 12 has a body 14, a head 16, a rump 18 and a plurality of legs 20. The head 16 has a pair of first wells 22 extending therein. Each of the first wells 22 is positioned on a crown of the head 16 and the first wells 22 are spaced apart from each other. The body 14 has a first lateral side 24 and a second lateral side 26. The rump 18 has a second well 28 extending therein, the first lateral side 24 has a third well 30 extending therein and the second lateral side 26 has a fourth well 32 extending therein.

A pair of pads 34 is provided and each of the pads 34 is selectively positioned in an associated one of the third 30 and fourth 32 wells. Each of the pads 34 is comprised of a deformable material. Thus, each of the pads 34 may receive a projectile during target practice. The projectile may be an arrow shot from a bow, a bullet from a small caliber rifle and any other projectile employed in the convention of hunting.

A pair of antlers 36 is provided and each of the antlers 36 is removably coupled to the head 16 on the decoy 12. In this way the decoy 12 is structured to selectively resemble a buck and a doe. Each of the antlers 36 has a basal end 38 and the basal end 38 corresponding to each of the antlers 36 engages a selected one of the first wells 22. In this way the corresponding antler 36 is removably coupled to the head 16.

A tail 40 is removably coupled to the rump 18 and the tail 40 is comprised of a fluid absorbent material. In this way the tail 40 selectively absorbs a liquid scent. Moreover, the tail 40 emits the scent to attract the deer. The scent may be doe estrus and any other liquid scent employed in the convention of hunting.

The tail 40 includes a clip 42 extending away from the tail 40. The clip 42 includes a leg 44 and a foot 46, and the foot 46 is spaced from the tail 40. The foot 46 engages the second well 28 when the tail 40 is positioned in the second well 28 to retain the tail 40 on the rump 18. The tail 40 additionally includes a plate 48 that abuts the rump 18 when the tail 40 is coupled to the rump 18. The plate 48 is comprised of a fluid impermeable material thereby inhibiting the liquid scent from contacting the decoy 12.

A call unit 50 is provided and the call unit 50 is coupled to the decoy 12. The call unit 50 selectively emits an audible sound to attract the deer to the decoy 12. The call unit 50 comprises a first processor 52 that is coupled to the decoy 12. The first processor 52 selectively generates a call sequence and the first processor 52 may be an electronic processor or the like.

An electronic memory 54 is coupled to the decoy 12 and the electronic memory 54 is electrically coupled to the first processor 52. The electronic memory 54 stores data pertaining to a first call, a second call and a third call. The first call may be the mating call of a buck deer, the second call may be the mating call of a doe deer and the third call may be the sound of rattling antlers. Moreover, the electronic memory 54 may be RAM, a hard disk drive and any other electronic means of storing digital data.

A speaker 56 is coupled to the decoy 12 and the speaker 56 emits audible sound outwardly therefrom. The speaker 56 is electrically coupled to the first processor 52 such that the speaker 56 selectively emits the first call, the second call and the third call. In this way the speaker 56 attracts a selected one of a buck and a doe to the decoy 12. The speaker 56 may be an electronic speaker 56 or the like.

A receiver 58 is coupled to the decoy 12 and the receiver 58 is electrically coupled to the first processor 52. The receiver 58 may be a radio frequency receiver 58 or the like. A first power supply 60 is coupled to the decoy 12 and the first power supply 60 is electrically coupled to the first processor 52. Moreover, the first power supply 60 comprises at least one battery.

A remote unit 62 is provided and the remote unit 62 is manipulated by a hunter. The remote unit 62 is in wireless electrical communication with the call unit 50. Thus, the remote unit 62 selectively actuates the call unit 50. The remote unit 62 comprises a remote control 64 and a second processor 65 that is coupled to the remote control 64.

A plurality of buttons 66 is provided and each of the buttons 66 is coupled to the remote control 64. Each of the buttons 66 is selectively manipulated and each of the buttons 66 is electrically coupled to the second processor 65. The plurality of buttons 66 includes a buck button, a doe button and a rattle button. A transmitter 68 is coupled to the remote control 64 and the transmitter 68 is electrically coupled to the second processor 65. Moreover, the transmitter 68 is in wireless electrical communication with the receiver 58. The transmitter 68 may be a radio frequency transmitter 68 or the like and the transmitter 68 may have an operational range ranging between approximately 15.0 meters and 30.0 meters.

The first processor 52 generates the call sequence when one of the buttons 66 is manipulated. The speaker 56 emits the first call when the buck button is manipulated to attract a doe. The speaker 56 emits the second call when the doe button is manipulated to attract a buck. Additionally, the speaker 56 emits the third call when the rattle button is manipulated to attract a buck. A second power supply 70 is positioned in the remote control 64 and the second power supply 70 is electrically coupled to the second processor 65. The second power supply 70 comprises at least one battery.

A pair of straps 72 is provided and each of the straps 72 is coupled to the remote control 64. The straps 72 may each include a buckle such that each of the straps 72 is selectively secured around the hunter's leg. In this way the remote control 64 is retained on the hunter.

In use, the decoy 12 is positioned at a selected location for the purposes of hunting. The antlers 36 are selectively coupled to the decoy 12 to attract a doe and the antlers 36 are selectively removed form the decoy 12 to attract a buck. The tail 40 is selectively coupled to the decoy 12 and the liquid scent is selectively applied to the tail 40. In this way the decoy 12 emits the scent to attract the buck and the doe. Additionally, each of the pads 34 is selectively coupled to the decoy 12 for target practice.

The remote control 64 is selectively manipulated to control the call unit 50 during hunting. The speaker 56 emits the first call when the buck button is manipulated. Thus, the first call attracts doe deer to the decoy 12. The speaker 56 emits the second call when the doe button is manipulated. In this way the second call attracts buck deer to the decoy 12. Additionally, the speaker 56 emits the third call when the rattle button is manipulated. In this way the third call attracts buck deer to the decoy 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A deer decoy assembly being configured to attract deer for hunting, said assembly comprising:
a decoy being configured to be positioned in a hunting area, said decoy being structured to resemble a deer wherein said decoy is configured to attract deer;
a pair of antlers, each of said antlers being removably coupled to said head on said decoy wherein said decoy is configured to selectively resemble a buck and a doe;
a tail being removably coupled to said rump, said tail being comprised of a fluid absorbent material such that said tail is selectively absorbs a liquid scent wherein said tail is configured to emit the scent to attract the deer;
a call unit being coupled to said decoy, said call unit selectively emitting an audible sound wherein said call unit is configured to attract the deer to said decoy; and
a remote unit being configured to be manipulated, said remote unit being in wireless electrical communication with said call unit such that said remote unit selectively actuates said call unit.

2. The assembly according to claim 1, wherein said decoy has a body, a head, a rump and a plurality of legs, said head having a pair of first wells extending therein, each of said first wells being positioned on a crown of said head, said first wells being spaced apart from each other, said body having a first lateral side and a second lateral side, said rump having a second well extending therein, said first lateral side having a third well extending therein, said second lateral side having a fourth well extending therein.

3. The assembly according to claim 2, further comprising a pair of pads, each of said pads being selectively positioned in an associated one of said third and fourth wells, each of said pads being comprised of a deformable material wherein each of said pads is configured to receive a projectile during target practice.

4. The assembly according to claim 2, wherein each of said antlers has a basal end, said basal end corresponding to each of said antlers engaging a selected one of said wells such that said corresponding antler is removably coupled to said head.

5. The assembly according to claim 2, wherein said tail includes a clip extending away from said tail, said clip including a leg and a foot, said foot being spaced from said tail, said foot engaging said second well when said tail is positioned in said second well to retain said tail on said rump.

6. The assembly according to claim 2, wherein said call unit comprises a first processor being coupled to said decoy, said first processor selectively generating a call sequence.

7. The assembly according to claim 6, further comprising an electronic memory being coupled to said decoy, said electronic memory being electrically coupled to said first processor, said electronic memory storing data pertaining to a first call, a second call and a third call.

8. The assembly according to claim 7, further comprising a speaker being coupled to said decoy wherein said speaker is configured to emit audible sound outwardly therefrom, said speaker being electrically coupled to said processor such that said speaker selectively emits said first call, said second call and said third call wherein said speaker is configured to attract a selected one of a buck and a doe to said decoy.

9. The assembly according to claim 6, further comprising a receiver being coupled to said decoy, said receiver being electrically coupled to said first processor.

10. The assembly according to claim 6, further comprising a first power supply being coupled to said decoy, said first power supply being electrically coupled to said first processor, said first power supply comprising at least one battery.

11. The assembly according to claim 1, wherein said remote unit comprises:
a remote control being configured to be manipulated; and
a second processor being coupled to said remote control.

12. The assembly according to claim 11, further comprising a plurality of buttons, each of said buttons being coupled to said remote control wherein each of said buttons is configured to be selectively manipulated, each of said buttons being electrically coupled to said second processor, said plurality of buttons including a buck button, a doe button and a rattle button.

13. The assembly according to claim 12, further comprising:
a first processor being coupled to said decoy;
a speaker being coupled to said decoy, said speaker selectively emitting a first call, a second call and a third call; and
a transmitter being coupled to said remote control, said transmitter being electrically coupled to said second processor, said transmitter being in wireless electrical communication with said receiver, said first processor generating said call sequence when one of said buttons is manipulated, said speaker emitting said first call when said buck button is manipulated wherein said speaker is configured to attract a doe, said speaker emitting said second call when said doe button is manipulated wherein said speaker is configured to attract a buck, said speaker emitting said third call when said rattle button is manipulated wherein said speaker is configured to attract a buck.

14. The assembly according to claim 11, further comprising a second power supply being positioned in said remote control, said second power supply being electrically coupled to said second processor, said second power supply comprising at least one battery.

15. A deer decoy assembly being configured to attract deer for hunting, said assembly comprising:
a decoy being configured to be positioned in a hunting area, said decoy being structured to resemble a deer wherein said decoy is configured to attract deer, said decoy having a body, a head, a rump and a plurality of legs, said head having a pair of first wells extending therein, each of said first wells being positioned on a crown of said head, said first wells being spaced apart from each other, said body having a first lateral side and a second lateral side, said rump having a second well extending therein, said first lateral side having a third well extending therein, said second lateral side having a fourth well extending therein;
a pair of pads, each of said pads being selectively positioned in an associated one of said third and fourth wells, each of said pads being comprised of a deformable material wherein each of said pads is configured to receive a projectile during target practice;
a pair of antlers, each of said antlers being removably coupled to said head on said decoy wherein said decoy is configured to selectively resemble a buck and a doe, each of said antlers having a basal end, said basal end corresponding to each of said antlers engaging a selected one of said wells such that said corresponding antler is removably coupled to said head;
a tail being removably coupled to said rump, said tail being comprised of a fluid absorbent material such that said tail is selectively absorbs a liquid scent wherein said tail is configured to emit the scent to attract the deer, said tail including a clip extending away from said tail, said clip including a leg and a foot, said foot being spaced from said tail, said foot engaging said second well when said tail is positioned in said second well to retain said tail on said rump;
a call unit being coupled to said decoy, said call unit selectively emitting an audible sound wherein said call unit is configured to attract the deer to said decoy, said call unit comprising:
a first processor being coupled to said decoy, said first processor selectively generating a call sequence,
an electronic memory being coupled to said decoy, said electronic memory being electrically coupled to said first processor, said electronic memory storing data pertaining to a first call, a second call and a third call,
a speaker being coupled to said decoy wherein said speaker is configured to emit audible sound outwardly therefrom, said speaker being electrically coupled to said processor such that said speaker selectively emits said first call, said second call and said third call wherein said speaker is configured to attract a selected one of a buck and a doe to said decoy,
a receiver being coupled to said decoy, said receiver being electrically coupled to said first processor, and
a first power supply being coupled to said decoy, said first power supply being electrically coupled to said first processor, said first power supply comprising at least one battery; and
a remote unit being configured to be manipulated, said remote unit being in wireless electrical communication with said call unit such that said remote unit selectively actuates said call unit, said remote unit comprising:
a remote control being configured to be manipulated,
a second processor being coupled to said remote control,
a plurality of buttons, each of said buttons being coupled to said remote control wherein each of said buttons is configured to be selectively manipulated, each of said buttons being electrically coupled to said second processor, said plurality of buttons including a buck button, a doe button and a rattle button,
a transmitter being coupled to said remote control, said transmitter being electrically coupled to said second processor, said transmitter being in wireless electrical communication with said receiver, said first processor generating said call sequence when one of said buttons is manipulated, said speaker emitting said first call when said buck button is manipulated wherein said speaker is configured to attract a doe, said speaker emitting said second call when said doe button is manipulated wherein said speaker is configured to attract a buck, said speaker emitting said third call when said rattle button is manipulated wherein said speaker is configured to attract a buck, and
a second power supply being positioned in said remote control, said second power supply being electrically coupled to said second processor, said second power supply comprising at least one battery.
